(19) United States
(12) Patent Application Publication
(10) Pub. No.: US 2006/0021268 A1
(43) Pub. Date: Feb. 2, 2006

(54) Multi-laminate three-dimensional display and methods therefore

(76) Inventor: Steven W. Ochs, Fairview, MT (US)

Correspondence Address: CONNOLLY BOVE LODGE & HUTZ LLP, SUITE 800, 1990 M STREET NW, WASHINGTON, DC, 20036-3425, US

(21) Appl. No.: 10/901,044

(22) Filed: Jul. 29, 2004

(51) Int. Cl. G09F 13/04

(52) U.S. Cl. 40/577

(57) ABSTRACT

The present invention relates generally to devices and methods for the display of artwork, and particularly, but not by way of limitation, to a method for giving an image an apparent three-dimensional character by causing an observer to view a series of color decompositions of the intended image.

### FIELD OF THE INVENTION

The present invention relates generally to devices and methods for the display of artwork, and particularly, but not by way of limitation, to a method for giving an image an apparent three-dimensional character by causing an observer to view a series of color decompositions of the intended image.

### BACKGROUND

The information provided below is not admitted to be prior art to the present invention, but is provided solely to assist the understanding of the reader.

The field of fine arts constantly strives to achieve novel and unexpected images and artistic effects. The fields of advertising and artisan graphics also seek new means of rendering visually-striking images. One such approach is embodied in U.S. Pat. No. 5,367,801, to Ahn, which provides a multi-layer, three-dimensional display. In Ahn, an image is synthesized from three, spaced-apart transparent panels each painted with a portion of the entire image. A front panel is painted with foreground details; a back panel is painted with background details; and a middle panel having other indecia adhered thereto. The overall effect is to render a scene having the appearance of depth.

The device of Ahn renders a three-dimensional scene. However, the various images that comprise the scene appear mono-dimensional. There is a need for a fine-arts display device that renders an image having a three-dimensional appearance.

### SUMMARY OF INVENTION

An aspect of the present invention provides a multi-layered display providing an image three-dimensional in appearance comprising a plurality of substantially transparent single-color layers, each said single-color layer having a decomposed color image applied there to, wherein said images are substantially in register in a mutually spaced and substantially parallel relation.

An aspect of the present invention provides a multi-layered display wherein each decomposed image is rendered in a process color of a color model. In a further aspect, the color model is the CMYK color model. In yet a further aspect, the color model is the RGB color model. In a related aspect, at least one process color is rendered by a plurality of sub-colors. In yet a further aspect, at least one colored image, whether in a process color or a sub-color, is rendered as a halftone.

An aspect of the present invention provides each single-color layer is spaced apart by a substantially transparent spacer layer. The spacer layer may be a material such as glass or a plastic such as Plexiglas. The spacer layer may be a gas such as air. In a further aspect, the single-color layer may comprise a separation layer. For example, a single-color image may be printed on a sheet of glass, wherein a thickness of the glass sheet comprises a separation layer.

An aspect of the present invention provides the various single-color layers and the various separation layers are substantially planar. Moreover, the various planes are mutually substantially parallel.

An aspect of the present invention provides a facial layer of a substantially transparent substance is disposed between the image layers and the position of an observer.

Still other objects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### BRIEF DESCRIPTION OF DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 depicts a side elevation of the inventive artwork display;

It is to be noted, however, that the appended drawings illustrate only typical embodiments of this invention and are therefore not to be considered limiting of its scope, for the invention may admit to other equally effective embodiments.

### DETAILED DESCRIPTION OF A PREFERRED EMBODIMENT

Reference is made to the figures to illustrate selected embodiments and preferred modes of carrying out the invention. It is to be understood that the invention is not hereby limited to those aspects depicted in the figures.

To print a full-color photo, or a graphic, with an offset printing press, one must first separate, or decompose, the photo into the four basic ink colors: cyan, magenta, yellow, and black (CMYK). Each color is then printed separately, as a single-color layer, one on top of the other, to give the impression of infinite colors. An aspect of the present invention arranges that an observer view a succession of single-color layers, mounted on transparent substrates, such that a full-color, three dimensional image is observed.

Process color separation is a method of mixing three or four colors to produce any of an infinite variety of colors. The three or four basic colors are known as “process colors.” CMYK is a color model in which all colors are described as a mixture of four process colors, cyan, magenta, yellow, and black. CMYK is the standard color model used in offset printing for full-color documents. Because such printing uses inks of these four basic colors, it is often called four-color printing. Display devices generally use a different color model called RGB, comprised of process colors, red, green, and blue. A preferred, but non-limiting, color model for the present invention is the CMYK model.

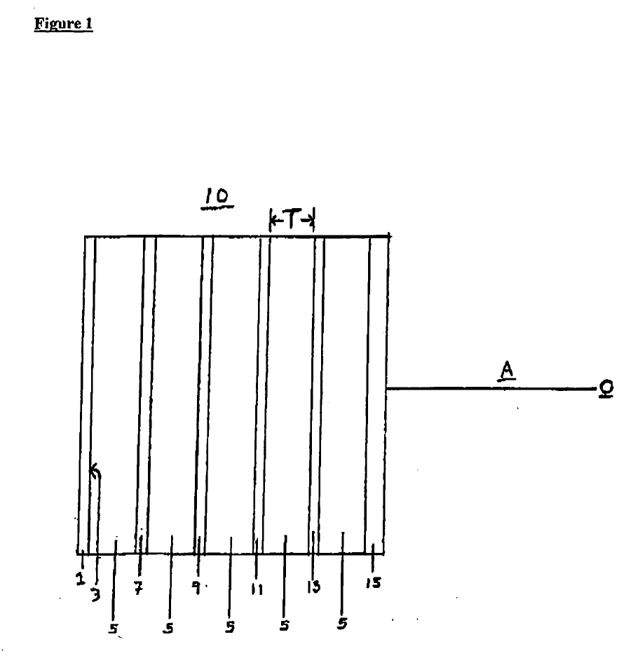

A side elevation of the inventive display is presented in FIG. 1. Display 10 comprises a plurality of substantially planar, parallel members 5, 7, 9, 11, and 13. Display 10 may optionally comprise substantially planar, parallel members 1 and 15.

Optional member 1 is a backing member, made of an opaque material such as wood or metal. Display 10 positioned such that an observer O, views member 1 through members 5, 7, 9, 11, 13, and optionally 15. Preferably, member I is coated with a reflective material. Preferably, the reflective material is colored white. Optional frontal member 15 is a substantially-transparent protective member.

Members 7, 9, 11, and 13 are single color layers. Members 5 are spacer layers. The spacer layers are made of a substance substantially-transparent to visible light. Substantially-transparent is defined in terms of the percentage of incident light that is transmitted through the layer. In an embodiment, at least 80% of visible light incident on spacer 5, in a direction parallel to the line of sight of observer O, is transmitted therethrough. In preferred embodiments, preferably at least 90% of the incident light is transmitted; more preferably at least 92%; more preferably at least 94%; more preferably at least 96%, more preferably at least 98% is transmitted. Spacer 5 may be an evacuated space, or a gas, such as air. Alternatively, spacer 5 may comprise a rigid material, such as glass or plastic, so long as it is substantially-transparent. Spacer 5 has a thickness T parallel to the line of sight of an observer O. Thickness T may be any thickness that enhances a visual effect of observing the image in the display.

Members 7, 9, 11, and 13 are single color layers. An image to be displayed is decomposed into an appropriate number of process colors and or sub-colors. Each decomposed image is rendered on a unique single color layer. Layers 7, 9, 11, and 13 are made of a substantially-transparent material. Layers 7, 9, 11, and 13 may be made from a mechanically rigid material such as glass or plastic. Alternatively, layers 7, 9, 11, and 13 may comprise a thin, mechanically compliant film. Where layers 7, 9, 11, and 13 comprise a thin film, the film may be mechanically supported by frame wherein the frame is disposed away from a viewing area. Alternatively, the film may be adhered to a face, a major surface, of a spacer member. In an embodiment, layers 7, 9, 11, and 13 may be rendered as a layer of ink, or other coloring matter, applied directly to a major surface of a spacer member. The coloring matter of a single color layer may be applied as an array of dots or pixels, such as a halftone image.

In a preferred embodiment, the various single color layer images are substantially in register. As used herein, the term “in register” means that the images are disposed such that an observer in position O (FIG. 1) appears to see substantially a single image. In other embodiments, the various images may be out of register.

In a preferred embodiment, a single color layer is rendered as a substantially planar image. In a preferred embodiment, the planes of the various images are substantially parallel. In an alternative embodiment, an image is rendered on the surface of a sphere or a sphereoid. When an image is rendered on the surface of a spheroid, it is preferred that the various spheroidal surfaces be substantially concentric.

In an embodiment, any or all of the spacer members and/or the single color layer members may be supported by a frame. Where a frame is used, it is preferred that the frame be disposed away from a viewing area

Although the illustrative embodiments of the invention are drawn from the fine, visual arts, the invention is not intrinsically limited to that art.

Furthermore, it is to be understood that the form of the invention shown and described is to be taken as presently preferred embodiments. Various modifications and changes may be made to each and every processing step as would be obvious to a person skilled in the art having the benefit of this disclosure. It is intended that the following claims be interpreted to embrace all such modifications and changes and, accordingly, the specification and drawings are to be regarded in an illustrative rather than a restrictive sense. Moreover, it is intended that the appended claims be construed to include alternative embodiments.

### INCORPORATION BY REFERENCE

All publications and patent applications cited in this specification are herein incorporated by reference, and for any and all purposes, as if each individual publication or patent application were specifically and individually indicated to be incorporated by reference. In the case of inconsistencies the present disclosure will prevail.

Having thus described our invention, what we claim as new, and desire to secure by Letters Patent is:

1. A multi-layered display providing an image three-dimensional in appearance comprising:
a plurality of substantially transparent single-color layers,
wherein said images are substantially in register in a mutually spaced and substantially parallel relation.

2. The multi-layered display, according to claim 1,
wherein each said image is spaced apart by a substantially transparent spacer layer.

3. The multi-layered display, according to claim 1,
wherein said single-color layer comprises said spacer layer.

4. The multi-layered display, according to claim 1, further comprising a frontal layer of a substantially transparent substance.

5. The multi-layered display, according to claim 1,
wherein each said decomposed image is a process color of a color model.

6. The multi-layered display, according to claim 5,
wherein said color model is the CMYK color model.

7. The multi-layered display, according to claim 5,
wherein said color model is the RGB color model.

8. The multi-layered display, according to claim 1,
wherein at least one decomposed image is a halftone image.

9. The multi-layered display, according to claim 5,
wherein at least one process color is decomposed into a plurality of sub-colors, and
wherein each process color and sub-color is applied to a unique single-color layer.

10. The multi-layered display, according to claim 1, further comprising a backing layer.

11. The multi-layered display, according to claim 10,
wherein said backing layer comprises a white, reflective coating.

12. The multi-layered display, according to claim 2,
wherein said substantially transparent layer transmits at least 80% of visible light incident thereon.

13. The multi-layered display, according to claim 1,
wherein said image is substantially planar.

14. The multi-layered display, according to claim 1,
wherein said image is rendered on at least a portion of a spheroid.
